(19) United States
(12) Patent Application Publication
(10) Pub. No.: US 2025/0229769 A1
(43) Pub. Date: Jul. 17, 2025

(54) PARKING ASSIST APPARATUS

(71) Applicants: TOYOTA JIDOSHA KABUSHIKI KAISHA, Aichi (JP); DENSO CORPORATION, Aichi-pref (JP)

(72) Inventor: Masayuki SHAKUTSUI, Nisshin-shi (JP)

(21) Appl. No.: 19/014,218

(22) Filed: Jan. 9, 2025

(30) Foreign Application Priority Data
Jan. 12, 2024 (JP) 2024-003153

(51) Int. Cl. B60W 30/06; B62D 15/02

(52) U.S. Cl. CPC B60W 30/06; B62D 15/0285

(57) ABSTRACT

To provide a parking assist apparatus capable of executing appropriate automatic parking control, a parking assist apparatus includes a parking assist ECU configured to execute automatic parking control of storing, as a registered route, a route along which an own vehicle has traveled until the own vehicle is parked at a predetermined parking position by a manual parking operation and parking the own vehicle at the predetermined parking position by causing the own vehicle to travel along the registered route. The parking assist ECU is configured to execute update processing of updating, when the own vehicle is parked at the predetermined parking position by a manual parking operation after the registered route is stored, the registered route based on information on the manual parking operation.

### BACKGROUND

### 1. Technical Field

The present disclosure relates to a parking assist apparatus.

### 2. Description of the Related Art

There has been known a parking assist apparatus capable of executing automatic parking control of storing, as a registered route, a route along which an own vehicle travels until the own vehicle is parked at a predetermined parking position by a parking operation executed through a manual driving of a driver (hereinafter referred to as “manual parking operation”) and parking the own vehicle at the predetermined parking position by causing the own vehicle to travel along the stored registered route (for example, see Japanese Patent Application Laid-open 2013-530867). The related-art parking assist apparatus (hereinafter sometimes referred to as “related-art apparatus”) capable of executing such automatic parking control assists in the travel and the parking of the own vehicle such that the registered route stored at the time of the execution of the automatic parking control is reproduced. Regarding the parking assist apparatus, in ISO 20900 (partially automated parking system (PAPS)) and ISO 16787 (assisted parking system (APS)) which are standards, vehicle control relating to the parking of a vehicle is defined.

With the related-art apparatus, even when the stored registered route is not appropriate, the automatic parking control is executed such that the inappropriate route is reproduced. For example, when an inappropriate route is stored as the registered route due to inexperienced driving of a driver, the own vehicle is controlled such that this inappropriate route is always reproduced when the automatic parking control is executed. Thus, there is a problem in that the driver of the own vehicle feels that appropriate automatic parking control is not executed by this apparatus, and hence a frequency of the use of this apparatus decreases.

### SUMMARY

The present disclosure has an object to provide a parking assist apparatus capable of solving the above-mentioned problem. That is, the present disclosure has an object to provide a parking assist apparatus capable of executing appropriate automatic parking control.

According to at least one embodiment of the present disclosure, there is provided a parking assist apparatus (1) including a control unit (10) configured to store, as a registered route, a route along which an own vehicle (100) has traveled until the own vehicle (100) is parked at a predetermined parking position by a manual parking operation, and to execute automatic parking control of parking the own vehicle (100) at the predetermined parking position by causing the own vehicle (100) to travel along the registered route, wherein the control unit (10) is configured to execute update processing of updating, when the own vehicle (100) is parked at the predetermined parking position by a manual parking operation after the registered route is stored, the registered route based on information on the manual parking operation (manual parking operation after the storage of the registered route).

With the parking assist apparatus according to the at least one embodiment of the present disclosure, even when the stored registered route is an inappropriate route, the registered route is updated based on the information on the manual parking operation after the storage of the registered route, and hence it is possible to bring the registered route closer to an appropriate route. As a result, appropriate automatic parking control can be executed.

In one aspect of the parking assist apparatus according to the at least one embodiment of the present disclosure, the control unit (10) is configured to: store, when the own vehicle (100) is parked at the predetermined parking position by a manual parking operation after the registered route is stored, as a post-registration manual parking route, a route along which the own vehicle (100) has traveled until the own vehicle (100) is parked at the predetermined parking position by the manual parking operation; and update, in the update processing, the registered route through use of the post-registration manual parking route.

Further, in another aspect of the parking assist apparatus according to the at least one embodiment of the present disclosure, the control unit (10) is configured to: store the post-registration manual parking route each time the own vehicle (100) is parked at the predetermined parking position by a manual parking operation after the registered route is stored, to thereby accumulate the post-registration manual parking route; and update, in the update processing, the registered route through use of the accumulated post-registration manual parking routes.

When the manual parking operation is executed after the registered route is stored, a driver of the own vehicle possibly recognizes that the registered route is inappropriate. Thus, the post-registration manual parking route, which is the route along which the own vehicle has traveled until the own vehicle is parked at the predetermined parking position by the manual parking operation after the registered route is stored, is highly probably a more appropriate route than the registered route. Thus, it is possible to bring the registered route closer to an appropriate route by updating the registered route through use of the post-registration manual parking route.

In yet another aspect of the parking assist apparatus according to the at least one embodiment of the present disclosure, in the update processing, the control unit (10) is configured to average the registered route and the post-registration manual parking routes, to thereby calculate an update route, and to update the registered route to the calculated update route. With this configuration, it is possible to bring the registered route closer to an appropriate route through use of a relatively simple method.

In still yet another aspect of the parking assist apparatus according to the at least one embodiment of the present disclosure, the control unit (10) is configured to execute exclusion processing of deleting abnormal data determined to be inappropriate as data to be used for the update processing from data representing the post-registration manual parking route. With this configuration, it is possible to quickly bring the registered route closer to an appropriate route by updating the registered route through use of the post-registration manual parking route from which the inappropriate data is excluded.

In still yet another aspect of the parking assist apparatus according to the at least one embodiment of the present disclosure, the abnormal data includes data indicating a route caused by a driving operation for avoiding an obstacle. When a driving operation for avoiding the obstacle such as a pedestrian is executed during the manual parking operation, the route greatly deviates from an appropriate route. Thus, it is possible to quickly bring the registered route closer to an appropriate route by updating the registered route through use of the post-registration manual parking route from which the data indicating the route acquired in such a situation is excluded.

### BRIEF DESCRIPTION OF THE DRAWINGS

FIG. 1 is a block diagram of a parking assist apparatus according to at least one embodiment of the present disclosure.

FIG. 2 is a view for illustrating an example of mounting positions of sonar sensors.

FIG. 3 is a view for illustrating an example of mounting positions of camera sensors.

FIG. 4 is a view for illustrating an example of a proposal image.

FIG. 5 is a view for illustrating an example of a registered route.

FIG. 6 is a view for illustrating another example of the registered route.

FIG. 7 is a view for illustrating an example of a post-registration manual parking route stored through execution of background storage processing.

FIG. 8 is a view for illustrating both of the registered route and the post-registration manual parking route.

FIG. 9 is a graph for showing both of a forward route of the registered route and a forward route of the post-registration manual parking route.

FIG. 10 is a graph for showing both of a backward route of the registered route and a backward route of the post-registration manual parking route.

FIG. 11 is a view for illustrating an update route.

FIG. 12 is a flowchart for illustrating an example of a program executed by a CPU for a parking assist ECU to execute usual storage processing.

FIG. 13 is a flowchart for illustrating an example of a program executed by the CPU for the parking assist ECU to execute automatic parking control.

FIG. 14 is a flowchart for illustrating an example of a program executed by the CPU for the parking assist ECU to execute the background storage processing.

FIG. 15 is a flowchart for illustrating an example of a program executed by the CPU for the parking assist ECU to execute update processing.

FIG. 16 is a view for illustrating an example of an inappropriate post-registration manual parking route stored through execution of the background storage processing.

FIG. 17 is a flowchart for illustrating an example of a program executed by the CPU for the parking assist ECU to execute exclusion processing.

FIG. 18 is a flowchart for illustrating an example of a program executed by the CPU for the parking assist ECU to execute notification processing.

### DESCRIPTION OF THE EMBODIMENTS

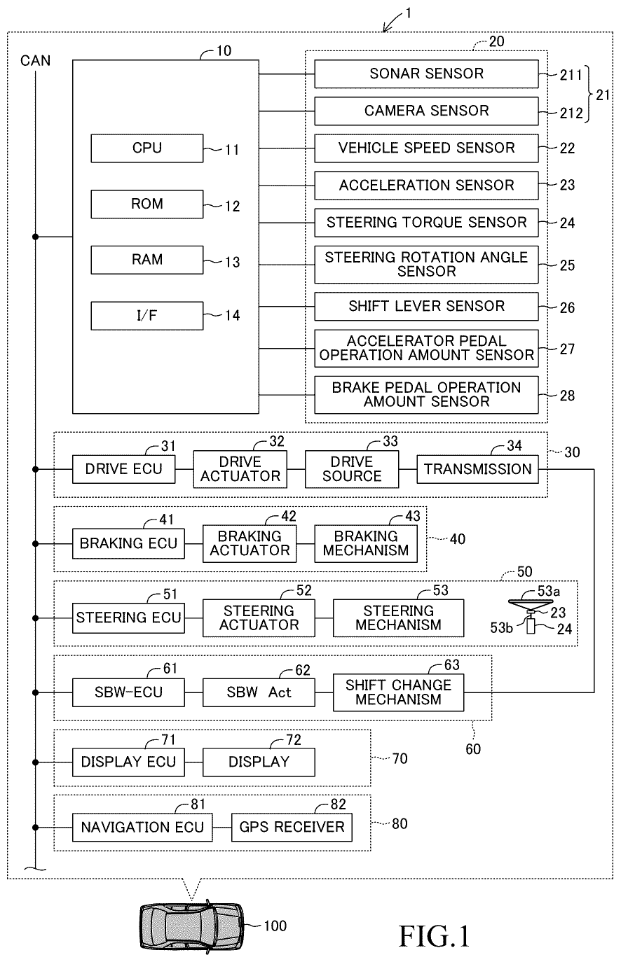

A parking assist apparatus according to at least one embodiment of the present disclosure is mounted to a vehicle. The vehicle to which the parking assist apparatus according to the at least one embodiment is mounted is hereinafter sometimes referred to as “own vehicle.” As illustrated in FIG. 1, a parking assist apparatus 1 includes a parking assist ECU 10, an in-vehicle sensor 20, a drive device 30, a braking device 40, a steering device 50, a shift change device 60, a display device 70, and a navigation device 80.

The parking assist ECU 10 is a control unit which includes, as a principal component, a microcomputer including a CPU 11, a ROM 12, a RAM 13, and an interface 14. The parking assist ECU 10 is configured to execute various types of control including automatic parking control by the CPU 11 executing instructions, programs, or routines stored in the ROM 12. The automatic parking control is control of parking the own vehicle 100 at a predetermined parking position by the parking assist apparatus 1 controlling at least one of the drive device 30, the braking device 40, or the steering device 50 of the own vehicle 100. Thus, control in which the parking assist apparatus 1 executes control of all of the drive device 30, the braking device 40, and the steering device 50 is also the automatic parking control, and control in which the parking assist apparatus 1 executes control of some of the devices, for example, control of only the steering device 50 is also the automatic parking control.

The parking assist ECU 10 may be formed of a plurality of ECUs. Moreover, the parking assist ECU 10 are connected to other plurality of ECUs via a controller area network (CAN). For example, as illustrated in FIG. 1, the parking assist ECU 10 is connected to a drive ECU 31, a braking ECU 41, a steering ECU 51, an SBW-ECU 61, a display ECU 71, and a navigation ECU 81, and can give and receive required information to and from each ECU connected to the parking assist ECU 10.

The drive device 30 generates a driving force, and applies this driving force to driving wheels of the own vehicle 100. The drive device 30 includes the drive ECU 31, a drive actuator 32, a drive source 33, a transmission 34, and a driving force transmission mechanism (not shown) which transmits the driving force to the driving wheels. The drive ECU 31 is electrically connected to the drive actuator 32 so that an operation of the drive actuator 32 can be controlled. The drive actuator 32 is configured to be able to adjust the driving force of the drive source 33 by being activated.

The drive ECU 31 controls an operation of the drive actuator 32, to thereby control a driving force generated by the drive source 33. The driving force generated by the drive source 33 is transmitted to the driving wheels of the own vehicle 100 via the transmission 34 and the driving force transmission mechanism. Thus, the drive ECU 31 can control the driving force of the own vehicle 100 by controlling the drive actuator 32. Moreover, the parking assist ECU 10 transmits, to the drive ECU 31, a drive control signal including information indicating a target driving force during the execution of the automatic parking control, to thereby be able to control the drive actuator 32 via the drive ECU 31 so that the driving force matches the target driving force. Moreover, the drive device 30 can generate the driving force also by a driver operating an accelerator pedal provided to the own vehicle 100.

When the drive source 33 is an internal combustion engine, the drive ECU 31 controls a driving force generated by the internal combustion engine. Moreover, when the own vehicle 100 is a hybrid electric vehicle (HEV), the drive ECU 31 controls a driving force generated by any one of or both of an internal combustion engine and an electric motor serving as the drive source 33. When the own vehicle 100 is a battery electric vehicle (BEV), the drive ECU 31 controls a driving force generated by an electric motor serving as the drive source 33.

The braking device 40 applies a braking force to wheels of the own vehicle 100. The braking device 40 includes the braking ECU 41, a braking actuator 42, and a braking mechanism 43. The braking ECU 41 is connected to the braking actuator 42 so that an operation of the braking actuator 42 can be controlled. The braking actuator 42 includes a publicly-known hydraulic circuit, and includes a reservoir (not shown), an oil pump (not shown), various valve devices (not shown), and the like. The braking mechanism 43 includes brake discs, calipers, pistons, and brake pads, and the brake pads are pressed against each brake disc by a hydraulic pressure (that is, a braking pressure) supplied from the braking actuator 42, to thereby generate a friction braking force. The own vehicle 100 is braked by the friction braking force generated by the braking mechanism 43.

The braking actuator 42 adjusts the hydraulic pressure (braking pressure) supplied to the braking mechanism 43 in accordance with an instruction from the braking ECU 41. The friction braking force generated by the braking mechanism 43 changes in accordance with the braking pressure. Thus, the braking ECU 41 can control the braking force of the own vehicle 100 by controlling the braking actuator 42. Moreover, the parking assist ECU 10 transmits, to the braking ECU 41, a braking control signal including information indicating a target braking force during the execution of the automatic parking control, to thereby be able to control the braking actuator 42 via the braking ECU 41 so that the braking force matches the target braking force. Moreover, the braking device 40 can apply the braking force to the wheels of the own vehicle 100 also by the driver operating a brake pedal provided to the own vehicle 100.

The steering device 50 is a device which serves to steer the own vehicle 100. The steering device 50 includes the steering ECU 51, a steering actuator 52, and a steering mechanism 53. The steering ECU 51 is electrically connected to the steering actuator 52 so that an operation of the steering actuator 52 can be controlled. The steering mechanism 53 includes a steering wheel 53a, a steering shaft 53b, a steering gear box (not shown), a tie rod (not shown), and the like. The steering mechanism 53 is configured to achieve steering of steered wheels of the own vehicle 100 through a rotation operation of the steering wheel 53a. The steering actuator 52 is, for example, an electric motor, and is connected to the steering mechanism 53 such that motive power to steer the steered wheels can be applied to the steering mechanism 53. This steering actuator 52 may also be configured to generate such a steering assist force as assisting in the operation of a driver on the steering wheel 53a. The steering ECU 51 controls an operation of the steering actuator 52, to thereby control the operation of the steering mechanism 53. Thus, the steering ECU 51 can control steering angles (actual steering angles) of the steered wheels of the own vehicle 100 by controlling the steering actuator 52. Moreover, the parking assist ECU 10 transmits, to the steering ECU 51, a steering control signal including information indicating a target steering angle during the execution of the automatic parking control, to thereby be able to control the steering actuator 52 via the steering ECU 51 so that the actual steering angle matches the target steering angle.

The shift change device 60 changes a shift position (gear position) of the transmission 34. In this example, the shift position includes at least a parking position, a neutral position, a forward position, and a reverse position. When the shift position is at the parking position, the shift change device 60 mechanically locks the wheels so that the driving force is not transmitted to the driving wheels and the wheels cannot rotate. Specifically, when the shift position is changed to the parking position, an output shaft of the transmission 34 is locked so that the output shaft does not rotate. This state is also referred to as “parking lock (P lock) state.” When the shift position is at the neutral position, the shift change device 60 does not transmit the driving force to the driving wheels. However, when the shift position is at the neutral position, the shift change device 60 does not mechanically lock the wheels. When the shift position is at the forward position, the shift change device 60 transmits, to the driving wheels, a driving force for causing the own vehicle 100 to travel forward. When the shift position is at the reverse position, the shift change device 60 transmits, to the driving wheels, a driving force for causing the own vehicle 100 to travel backward.

The shift change device 60 includes the SBW-ECU 61, an SBW actuator 62, a shift change mechanism 63, and the like. “SBW” is an abbreviation for “shift by wire.” The SBW-ECU 61 is electrically connected to the SBW actuator 62. The SBW-ECU 61 controls the SBW actuator 62 based on an operation position of a shift lever provided to the own vehicle 100. The shift lever is an operation element for operating the shift position of the transmission 34, and is operated by the driver of the own vehicle 100. The shift lever is configured to be able to move to an operation position corresponding to each shift position. The SBW actuator 62 activates the shift change mechanism 63 in accordance with an instruction from the SBW-ECU 61, to thereby change the shift position of the transmission 34 to any one of the plurality of shift positions (parking position, neutral position, forward position, and reverse position). Moreover, the parking assist ECU 10 transmits, to the SBW-ECU 61, a shift control signal including information indicating a target shift position during the execution of the automatic parking control, to thereby be able to control the SBW actuator 62 via the SBW-ECU 61 so that the shift position matches the target shift position.

The display device 70 includes the display ECU 71 and a display 72 of a touch panel type. The display ECU 71 is electrically connected to the display 72 so that the display ECU 71 can control the display 72. As the display 72, a display mounted to an instrument panel provided directly in front of a driver's seat of the own vehicle 100 can be exemplified. The display 72 may be a navigation display which usually displays a map screen. Moreover, the parking assist ECU 10 transmits a predetermined display control signal to the display ECU 71, to thereby be able to control the display device 70 so that predetermined information is displayed on the display 72. The display device 70 has a function as a notification device which gives notification of predetermined information via the display 72. Moreover, the display device 70 has a function as an input device which receives input of predetermined information via the display 72.

The navigation device 80 includes the navigation ECU 81 and a GPS receiver 82. The GPS receiver 82 receives GPS signals for detecting the longitude and the latitude of a current position of the own vehicle 100. Moreover, the navigation device 80 is provided with a map database which stores map information. The navigation ECU 81 executes various types of calculation processing based on the longitude and the latitude of the own vehicle 100 obtained through use of the GPS signals received by the GPS receiver 82, the map information, and the like, to thereby identify a position of the own vehicle 100 on a map. The identified position of the own vehicle 100 is transmitted to the parking assist ECU 10, and is used for the automatic parking control.

The in-vehicle sensor 20 includes a peripheral information detection sensor 21, a vehicle speed sensor 22, an acceleration sensor 23, a steering torque sensor 24, a steering rotation angle sensor 25, a shift lever sensor 26, an accelerator pedal operation amount sensor 27, and a brake pedal operation amount sensor 28. The peripheral information detection sensor 21 detects peripheral information which is information on a peripheral environment of the own vehicle 100. In the at least one embodiment, the peripheral information detection sensor 21 includes a sonar sensor 211 and a camera sensor 212.

The sonar sensor 211 is electrically connected to the parking assist ECU 10. The sonar sensor 211 intermittently emits an ultrasonic wave to a peripheral region of the own vehicle 100, and receives an ultrasonic wave (reflected wave) reflected by a three-dimensional object (object). The sonar sensor 211 acquires a distance between the own vehicle 100 and the object, a relative positional relationship between the own vehicle 100 and the object, and the like based on a period of time from the transmission of the ultrasonic wave to the reception of the reflected wave. The sonar sensor 211 transmits information indicating the acquired distance and positional relationship to the parking assist ECU 10. The parking assist ECU 10 acquires information on the relationship between the object existing in the periphery of the own vehicle 100 and the own vehicle 100 based on the information received from the sonar sensor 211.

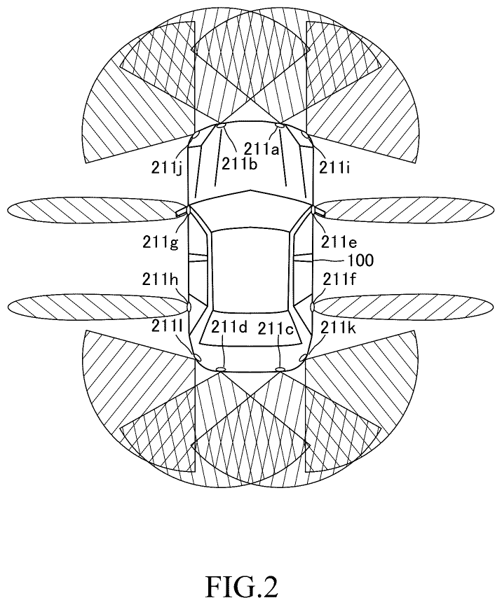

In the at least one embodiment, a plurality of the sonar sensors 211 are provided to the own vehicle 100. The plurality of sonar sensors 211 are provided to the own vehicle 100 such that the ultrasonic wave can be emitted to a substantially entire periphery of the own vehicle 100. For example, as illustrated in FIG. 2, the plurality of sonar sensors 211 may include front sonar sensors 211a and 211b, rear sonar sensors 211c and 211d, right sonar sensors 211e and 211f, left sonar sensors 211g and 211h, a right front sonar sensor 211i, a left front sonar sensor 211j, a right rear sonar sensor 211k, and a left rear sonar sensor 211l. The front sonar sensors 211a and 211b emit the ultrasonic waves forward from a right portion and a left portion on a front end of the own vehicle 100, respectively. The rear sonar sensors 211c and 211d emit the ultrasonic waves backward from a right portion and a left portion on a rear end of the own vehicle 100, respectively. The right sonar sensors 211e and 211f emit the ultrasonic waves rightward from a front portion and a rear portion on a right lateral end of the own vehicle 100, respectively. The left sonar sensors 211g and 211h emit the ultrasonic waves leftward from a front portion and a rear portion on a left lateral end of the own vehicle 100, respectively. The right front sonar sensor 211i emits the ultrasonic wave right diagonally forward from a right front end portion of the own vehicle 100. The left front sonar sensor 211j emits the ultrasonic wave left diagonally forward from a left front end portion of the own vehicle 100. The right rear sonar sensor 211k emits the ultrasonic wave right diagonally backward from a right rear end portion of the own vehicle 100. The left rear sonar sensor 211l emits the ultrasonic wave left diagonally backward from a left rear end portion of the own vehicle 100.

The camera sensor 212 is electrically connected to the parking assist ECU 10. The camera sensor 212 includes camera devices and an image analysis device. The camera devices are each a digital camera which incorporates a lens and an image pickup element formed of, for example, a charge coupled device (CCD) or a CMOS image sensor (CIS). Each of the camera devices images the peripheral region of the own vehicle 100 at a predetermined frame rate, to thereby acquire image data. The camera device transmits each piece of image data to the image analysis device. The image analysis device analyzes the acquired image data, to thereby acquire information on objects and markings existing around the own vehicle 100. The image analysis device recognizes, for example, a marking, a pattern, and a shape of a travel road surface, shapes and colors of a wall, a fence, and the like of a parking space, and a parking frame line displayed on the road surface, and transmits image information indicating results of the recognition to the parking assist ECU 10. The parking assist ECU 10 acquires information on the objects and the markings existing in the periphery of the own vehicle 100 based on the information received from the image analysis device.

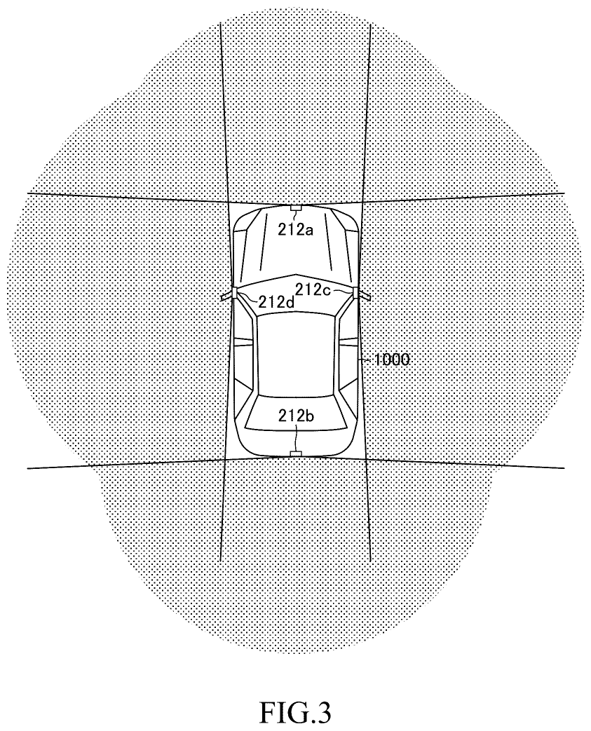

The camera sensor 212 includes a plurality of camera devices such that the entire periphery of the own vehicle 100 can be photographed. For example, as illustrated in FIG. 3, the plurality of camera devices may include a front camera device 212a, a rear camera device 212b, a right lateral camera device 212c, and a left lateral camera device 212d. The front camera device 212a photographs (images) a front region of the own vehicle 100. The rear camera device 212b photographs (images) a rear region of the own vehicle 100. The right lateral camera device 212c photographs (images) a right lateral region of the own vehicle 100. The left lateral camera device 212d photographs (images) a left lateral region of the own vehicle 100. An angle of view of each camera device is about 180°, or may be 180° or more, so that the entire periphery of the own vehicle 100 can be photographed. Moreover, the plurality of camera devices may include infrared camera devices so that the periphery of the own vehicle 100 can be photographed even at night.

The peripheral information detection sensor 21 may include a radar sensor. The radar sensor is configured to be able to detect an object existing in the periphery of the own vehicle 100 through use of a radio wave in the millimeter wave band. In this case, the radar sensor may include a front radar sensor which emits the radio wave in a forward direction of the own vehicle 100, a rear radar sensor which emits the radio wave in a backward direction of the own vehicle 100, a right lateral radar sensor which emits the radio wave in a rightward direction of the own vehicle 100, and a left lateral radar sensor which emits the radio wave in a leftward direction of the own vehicle 100.

The vehicle speed sensor 22 is electrically connected to the parking assist ECU 10. The vehicle speed sensor 22 detects information indicating a vehicle speed of the own vehicle 100, and transmits information indicating the detected vehicle speed to the parking assist ECU 10. The parking assist ECU 10 acquires the vehicle speed of the own vehicle 100 based on the information received from the vehicle speed sensor 22. The vehicle speed sensor 22 may be a wheel speed sensor which detects information indicating a rotation speed of the wheel of the own vehicle 100.

The acceleration sensor 23 is electrically connected to the parking assist ECU 10. The acceleration sensor 23 detects information indicating an acceleration (longitudinal acceleration) acting in a front-and-rear direction of the own vehicle 100, and transmits information indicating the detected acceleration to the parking assist ECU 10. The parking assist ECU 10 acquires the acceleration acting in the front-and-rear direction of the own vehicle 100 based on the information received from the acceleration sensor 23.

The steering torque sensor 24 detects information indicating a torque (steering torque) input when the driver of the own vehicle 100 steers the steering wheel 53a. The steering torque sensor 24 is mounted to, for example, the steering shaft 53b which rotates integrally with the steering wheel 53a, and detects, as the steering torque, a torsional torque generated by the rotation of the steering wheel 53a. The steering torque sensor 24 is electrically connected to the parking assist ECU 10, and transmits information indicating the detected steering torque to the parking assist ECU 10. The parking assist ECU 10 acquires the steering torque based on the information received from the steering torque sensor 24.

The steering rotation angle sensor 25 detects a rotation angle of the steering shaft 53b with respect to a neutral position. The steering rotation angle sensor 25 detects, as a positive angle, an angle given when the steering shaft 53b is rotated toward one direction (for example, a right direction) from the neutral position, and detects, a negative angle, an angle given when the steering shaft 53b is rotated toward the other direction (for example, left direction). The steering rotation angle sensor 25 is electrically connected to the parking assist ECU 10, and transmits information indicating the rotation angle of the steering shaft 53b to the parking assist ECU 10. The parking assist ECU 10 acquires the steering rotation angle based on the information received from the steering rotation angle sensor 25.

The shift lever sensor 26 detects information indicating the operation position of the shift lever. The shift lever sensor 26 is electrically connected to the parking assist ECU 10, and transmits information indicating the detected operation position of the shift lever to the parking assist ECU 10. The parking assist ECU 10 acquires the shift position of the transmission 34 based on the information received from the shift lever sensor 26. The information detected by the shift lever sensor 26 is also received by the SBW-ECU 61.

The accelerator pedal operation amount sensor 27 is electrically connected to the parking assist ECU 10, and detects information indicating an operation amount (stroke amount) of the accelerator pedal provided to the own vehicle 100. The accelerator pedal operation amount sensor 27 transmits information indicating the detected operation amount of the accelerator pedal to the parking assist ECU 10. The parking assist ECU 10 acquires the operation amount of the accelerator pedal based on the information received from the accelerator pedal operation amount sensor 27.

The brake pedal operation amount sensor 28 is electrically connected to the parking assist ECU 10, and detects information indicating an operation amount (stroke amount) of the brake pedal provided to the own vehicle 100. The brake pedal operation amount sensor 28 transmits information indicating the detected operation amount of the brake pedal to the parking assist ECU 10. The parking assist ECU 10 acquires the operation amount of the brake pedal based on the information received from the brake pedal operation amount sensor 28.

The in-vehicle sensor 20 includes sensors other than the sensors described above. For example, a yaw rate sensor which detects yaw rate of the own vehicle 100 and a travel direction detection sensor which detects a lighting state of a direction indicator (turn signal) provided to the own vehicle 100 are included in the in-vehicle sensor 20.

### (Overview of Operation)

### 1. Usual Storage Processing

The parking assist apparatus 1 having the above-mentioned configuration is configured to able to execute usual storage processing of storing, when the own vehicle 100 is parked at a predetermined parking position by a manual driving operation of the driver, this parking position and a route (hereinafter sometimes referred to as “parking route”) along which the own vehicle 100 has traveled until the own vehicle 100 is parked at this parking position. The parking route includes a route along which the own vehicle 100 travels until the own vehicle 100 reaches a neighborhood position of the parking position and a route along which the own vehicle 100 travels by a parking operation performed until the own vehicle 100 which has reached the neighborhood position of the parking position is parked at the parking position. The manual driving operation of the driver performed until the own vehicle 100 is parked at the parking position along the parking route is referred to as “manual parking operation.” Thus, in the usual storage processing, the route along which the own vehicle 100 travels until the own vehicle 100 is parked at the predetermined parking position by the manual parking operation is stored. Description is now given of this usual storage processing.

The parking assist ECU 10 of the parking assist apparatus 1 determines whether or not a record start condition is satisfied when the driver of the own vehicle 100 is manually driving the own vehicle 100. Whether or not the record start condition is satisfied is determined when a registered position and a registered route described later are not set to a neighborhood region of the own vehicle 100. The record start condition is set in advance as a condition which is satisfied when the driver of the own vehicle 100 highly probably parks the own vehicle 100 by the manual parking operation. For example, in a case in which a position of the home of the driver of the own vehicle 100 is stored in the parking assist ECU 10, when the current position of the own vehicle 100 is close to the position of the home and the speed of the own vehicle 100 is equal to or lower than a predetermined speed, the parking assist ECU 10 determines that the driver of the own vehicle 100 is highly probably driving the own vehicle 100 such that the driver parks the own vehicle 100 in a parking space of the home. In this case, the record start condition is satisfied.

When the record start condition is satisfied, the parking assist ECU 10 executes the route record processing. In the route record processing, the parking assist ECU 10 continuously records travel information on the own vehicle 100 each time a predetermined short period of time elapses in a ring buffer area provided in the RAM 13. The travel information continuously recorded each time the predetermined short period of time elapses includes information with which the travel route of the own vehicle 100 can be identified and information indicating a travel state of the own vehicle 100. The information with which the travel route of the own vehicle 100 can be identified includes information (peripheral image information) on the markings on the road surface, the pattern of the road surface, and the shape of the road surface continuously acquired by the parking assist ECU 10 from the camera sensor 212 and information on a position of the own vehicle 100 received by the GPS receiver 82. The information indicating the travel state of the own vehicle 100 includes the information indicating the vehicle speed of the own vehicle 100 received from the vehicle speed sensor 22, the information indicating the acceleration of the own vehicle 100 received from the acceleration sensor 23, the information indicating the steering torque received from the steering torque sensor 24, the information indicating the steering rotation angle received from the steering rotation angle sensor 25, the information indicating the operation position of the shift lever (shift position of the transmission 34) received from the shift lever sensor 26, the information indicating the operation amount of the accelerator pedal received from the accelerator pedal operation amount sensor 27, the information indicating the operation amount of the brake pedal received from the brake pedal operation amount sensor 28, the information indicating the yaw rate of the own vehicle 100 received from the yaw rate sensor, the information indicating the lighting state of the direction indicator received from the travel direction detection sensor, and the like. The information indicating the travel state of the own vehicle 100 is continuously acquired in correspondence to the continuously acquired peripheral image information. The parking assist ECU 10 executes the route record processing, to thereby continuously record the travel information on the vehicle 100 in a predetermined period before the current time.

When the own vehicle 100 reaches the neighborhood position of the parking position, the driver of the own vehicle 100 performs the parking operation for parking the own vehicle 100 at the parking position. As a result, the own vehicle 100 is parked at the predetermined parking position by the manual operation of the driver. During the execution of the parking operation of the own vehicle 100, the parking assist ECU 10 continues to record the travel information on the own vehicle 100.

When the parking assist ECU 10 determines that the parking of the own vehicle 100 at the parking position is completed by the manual parking operation, the parking assist ECU 10 records information with which the parking position can be identified in the RAM 13. In this case, for example, information on a shape of the parking position, information on feature points in the parking position, information of the parking frame line, position information on the parking position, and the like, which are acquired by the camera sensor 212, are recorded.

Moreover, when the parking assist ECU 10 determines that the parking of the own vehicle 100 at the parking position is completed, the parking assist ECU 10 controls the display device 70 so that an image for selecting whether or not the parking position and the parking route are to be registered is displayed on the display 72. After that, when the registration of the parking position and the parking route is selected, the parking assist ECU 10 calculates the parking route. For example, the parking assist ECU 10 calculates coordinate components of a group of points indicating the parking route on a two-dimensional coordinate plane extending in a horizontal direction from an origin set to the position of the own vehicle 100 parked at the parking position. In this case, it is possible to calculate the parking route through use of the position of the own vehicle 100 parked at the parking position and the information (steering rotation angle, vehicle speed, acceleration, and the like) indicating the travel state of the own vehicle 100 until the parking at the parking position.

After that, the parking assist ECU 10 stores, in a predetermined storage area in the ROM 12, data indicating the calculated parking route, data indicating the parking position, data on the information with which the parking route (peripheral image information) can be identified, and data on the information on the travel state of the own vehicle 100 which has traveled along the parking route. As a result, the parking position and the parking route are registered. The parking position stored in the ROM 12 through the usual storage processing is hereinafter referred to as “registered position,” and the parking route stored in the ROM 12 through the usual storage processing is referred to as “registered route.”

In the above-mentioned example, the route record processing is executed when the record start condition is satisfied. However, the record start condition can be omitted. In this case, the parking assist ECU 10 always executes the route record processing during the travel of the own vehicle 100. Then, the image for selecting whether or not the parking position and the parking route are to be registered is displayed on the display 72 when the parking of the own vehicle 100 is completed. When the registration of the parking position and the parking route is selected, the parking assist ECU 10 stores information recorded in the RAM 13 in the predetermined storage area in the ROM 12.

### 2. Automatic Parking Control

The parking assist apparatus 1 according to the at least one embodiment is also configured to be able to execute the automatic parking control. Through the execution of this automatic parking control, the own vehicle 100 automatically or semi-automatically travels along the stored registered route, and the own vehicle 100 is then automatically or semi-automatically parked at the registered position. The parking assist ECU 10 may control all of the devices (the drive device 30, the braking device 40, the steering device 50, the shift change device 60, and the like) for controlling the movement of the own vehicle 100 during the execution of the automatic parking control, or may control only some of the devices. Description is now given of this automatic parking control.

The parking assist ECU 10 determines whether or not the own vehicle 100 is traveling at a speed equal to or lower than a predetermined speed (for example, equal to or lower than 15 km/H) in a neighborhood of the registered position or the registered route based on the current position of the own vehicle 100 during the travel of the own vehicle 100 by the manual driving operation of the driver. When the own vehicle 100 is traveling at a speed equal to or lower than the predetermined speed in a neighborhood of the registered position or the registered route, the parking assist ECU 10 controls the display 72 such that a proposal image is displayed on the display 72.

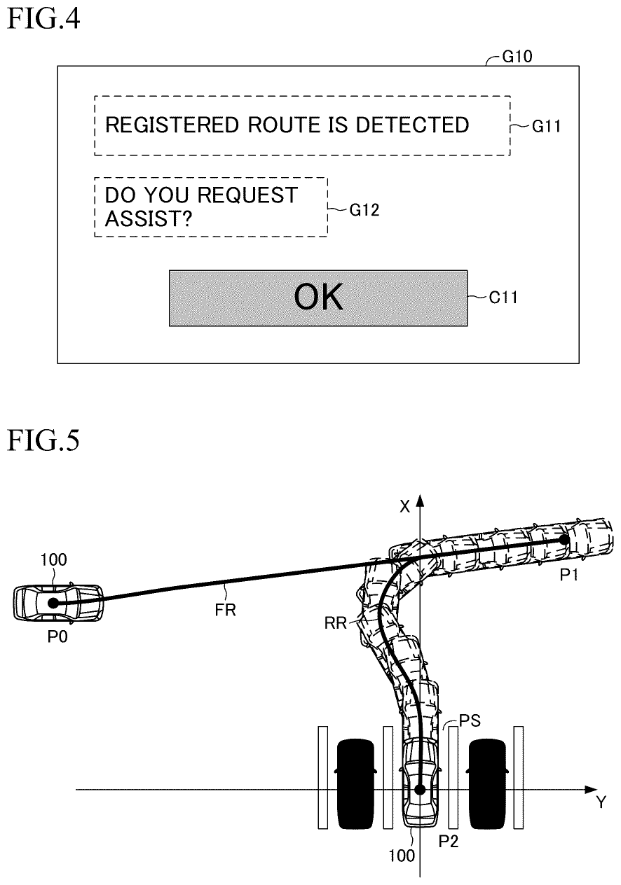

FIG. 4 is a view for illustrating an example of the proposal image. As illustrated in FIG. 4, a proposal image G10 includes a first character image G11, a second character image G12, and a start icon C11. The first character image G11 indicates the detection of the registered route. The second character image G12 indicates the proposal of the execution of the automatic parking control.

An occupant of the own vehicle 100 taps the start icon C11 when the occupant desires the execution of the automatic parking control. When the start icon C11 is tapped, a control start signal is transmitted from the display ECU 71 to the parking assist ECU 10. When the parking assist ECU 10 receives the control start signal, the parking assist ECU 10 determines that a control start condition is satisfied and starts the execution of the automatic parking control. Meanwhile, when the occupant of the own vehicle 100 does not wish the execution of the automatic parking control, the occupant does not tap the start icon C11. When a predetermined period of time (for example, five seconds) elapses without receiving the control start signal after the proposal image G10 is displayed on the display 72, the parking assist ECU 10 controls the display device 70 such that the proposal image G10 is removed from the display 72. In this case, the parking assist ECU 10 determines that the control start condition is not satisfied, and does not execute the automatic parking control.

When the execution of the automatic parking control is started, the parking assist ECU 10 identifies the current position of the own vehicle 100. The parking assist ECU 10 then calculates a merging route which is a route along which the own vehicle 100 travels until the travel route of the own vehicle 100 merges with the registered route. In this case, even when the own vehicle 100 is traveling on a road to which the registered route is set, a travel position of the own vehicle 100 may deviate from the registered route. Thus, the parking assist ECU 10 calculates the merging route as the route along which the own vehicle 100 travels until the travel route of the own vehicle 100 matches the registered route.

After the calculation of the merging route, the parking assist ECU 10 controls one or more devices out of the drive device 30, the braking device 40, and the steering device 50 of the own vehicle 100 such that the own vehicle 100 travels along the merging route. As a result, the own vehicle 100 automatically travels at a predetermined low speed along the merging route up to a merging point between the registered route and the merging route. After that, the own vehicle 100 travels along the registered route from the merging point. When the own vehicle 100 travels along the registered route, the parking assist ECU 10 controls the own vehicle 100 such that the information (peripheral image information) acquired from the camera sensor 212 and the information (peripheral image information) which is information stored in the ROM 12 and with which the registered route can be identified match each other. For example, the parking assist ECU 10 controls the own vehicle 100 such that a position of a feature point in the peripheral image acquired from the camera sensor 212 at the time when the own vehicle 100 is traveling at a certain point of the registered route through the automatic parking control matches a position of the feature point in a peripheral image with which this point can be identified out of the stored peripheral images. As a result, the own vehicle 100 travels along the registered route. Moreover, when the own vehicle 100 travels along the registered route, the parking assist ECU 10 controls the own vehicle 100 such that a travel state matching a stored travel state (the speed, the acceleration, the steering angle, and the like) is achieved. As a result, the travel route and the travel state until the parking of the own vehicle 100 at the registered position by the manual parking operation are reproduced. The own vehicle 100 is automatically parked at the registered position by this automatic parking control.

FIG. 5 is a view for illustrating an example of the registered route. In FIG. 5, the registered route is indicated as a thick solid line. The registered route of FIG. 5 is expressed on a two-dimensional X-Y coordinate plane having, as an origin, the own vehicle 100 parked at a predetermined parking position P2 in a parking space PS, an X axis extending in the front-and-rear direction of the own vehicle 100, and a Y axis extending in a vehicle width direction of the own vehicle 100. The registered route of FIG. 5 is formed of a forward route FR along which the own vehicle 100 travels forward from a start position P0 of the automatic parking control to a turn-back position P1 and a backward route RR along which the own vehicle 100 travels backward from the turn-back position P1 to the parking position P2 in the parking space PS. In the example of FIG. 5, the forward route FR is such a route that the forward route FR gradually departs from the parking position P2 in the X direction as the forward route FR approaches the turn-back position P1 from the start position P0. Moreover, the turn-back position P1 is at a position exceeding the parking position P2 in the Y direction. Further, the backward route RR is such a route that the backward route RR returns after the excess in the Y direction (negative direction) and reaches the parking position P2.

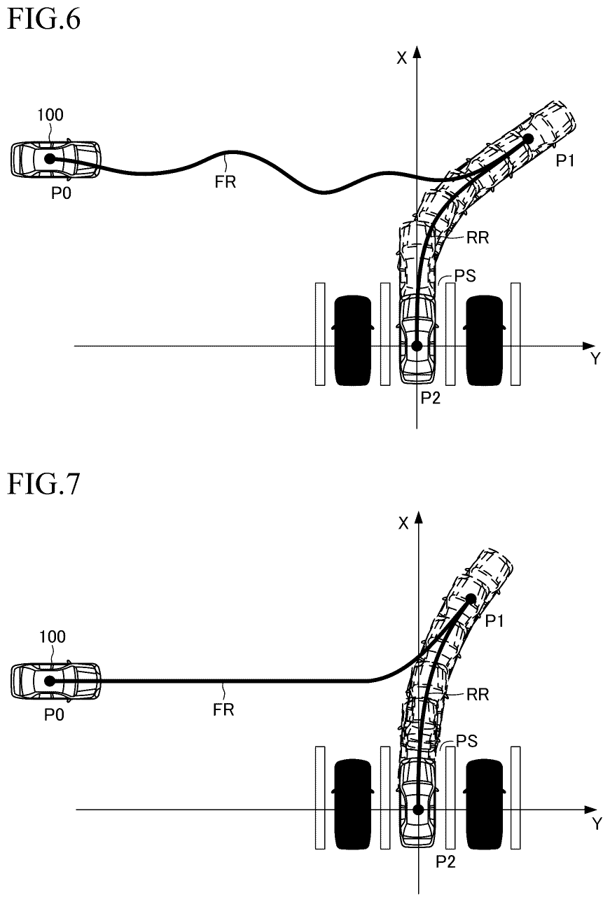

FIG. 6 is a view for illustrating another example of the registered route. The registered route of FIG. 6 is also indicated on the two-dimensional X-Y coordinate plane of FIG. 5. The registered route of FIG. 6 is formed of the forward route FR and the backward route RR similarly to the registered route of FIG. 5. In the example of FIG. 6, the forward route FR meanders from the start position P0 to the turn-back position P1.

The registered routes of FIG. 5 and FIG. 6 include large amounts of wasteful travel routes in each route of the own vehicle 100 from the start position P0 to the parking position P2 via the turn-back position P1, and hence are not appropriate routes. However, in the related-art apparatus, when the route is stored as the registered route, the own vehicle 100 is controlled such that this registered route is reproduced when the automatic parking control is executed, and hence even wasteful routes are reproduced. When the registered route is not an appropriate route as described above, the driver of the own vehicle 100 feels that appropriate automatic parking control is not executed, that is, the own vehicle 100 cannot be parked through the travel along an appropriate route. Thus, the driver subsequently often avoids further use of the automatic parking control. Thus, in the related-art apparatus, it is concerned that the automatic parking control is not fully used.

In this respect, the parking assist ECU 10 of the parking assist apparatus 1 according to the at least one embodiment is configured to be able to execute update processing for the registered route. The registered route can be brought closer to a more appropriate route by executing this update processing. The update processing is processing of updating, when the own vehicle 100 is parked at the registered position by the manual parking operation after the registered route is stored, the registered route based on information on this manual parking operation. The information on the manual parking operation is travel information acquired by the parking assist ECU 10 when the own vehicle 100 travels by the manual parking operation and information on a parking route calculated based on this travel information. In order to execute this update processing, the parking assist ECU 10 executes background storage processing, to thereby store the travel information acquired until the own vehicle 100 is parked at the registered position by the manual parking operation after the registered route is stored and the parking route calculated through use of this travel information. Description is now given of the background storage processing.

### 3. Background Storage Processing

It is assumed that the parking assist ECU 10 has stored the route of FIG. 5 as the registered route. The parking assist ECU 10 determines whether or not the own vehicle 100 is traveling at a speed equal to or lower than the predetermined speed (for example, equal to or lower than 15 km/H) in a neighborhood of the registered position or the registered route based on the current position of the own vehicle 100 during the manual travel of the own vehicle 100. When the own vehicle 100 is traveling at a speed equal to or lower than the predetermined speed in a neighborhood of the registered position or the registered route, the parking assist ECU 10 controls the display 72 such that the proposal image G10 of FIG. 4 is displayed on the display 72.

The parking assist ECU 10 determines that the control start condition for the automatic parking control is not satisfied when the predetermined period of time elapses without the start icon C11 in the proposal image G10 displayed on the display 72 being tapped. The case in which the proposal image G10 is displayed on the display 72 is the case in which the registered route and the registered position have already been stored and the own vehicle 100 is traveling at the reduced speed in a neighborhood of the registered route and the registered position. Thus, the driver of the own vehicle 100 highly probably has an intention of parking the own vehicle 100 at the registered position. When the driver of the own vehicle 100 does not select the automatic parking control even in this case, the driver of the own vehicle 100 highly probably has an intention of parking the own vehicle 100 at the registered position by the manual parking operation. Thus, the driving operation of the driver of the own vehicle 100 after the predetermined period of time has elapsed without the start icon C11 in the proposal image G10 being tapped can be determined as the manual parking operation for parking the own vehicle 100 at the registered position. When the parking assist ECU 10 determines that the own vehicle 100 is to be parked at the registered position by the manual parking operation after the storage of the registered route in this way, the parking assist ECU 10 executes the route record processing.

In the route record processing, the parking assist ECU 10 continuously records the travel information on the own vehicle 100 each time the predetermined short period of time elapses in the ring buffer area provided in the RAM 13. After that, when the parking of the own vehicle 100 at the registered position is completed, the parking assist ECU 10 calculates the parking route along which the own vehicle 100 has traveled until the own vehicle 100 is parked at the registered position by the current manual parking operation. In this case, the parking route may be calculated by the same method as the method of calculating the registered route. Moreover, a deviation amount between the registered route and the current parking route may be calculated through comparison between the peripheral image information acquired through the current route record processing and the peripheral image information with which the registered route can be identified, and the parking route may then be calculated based on this deviation amount.

After that, the parking assist ECU 10 stores, together with the recorded travel information, the calculated parking route in the ROM 12. The execution of the route record processing is not notified to occupants of the own vehicle 100 including the driver during the execution of the background storage processing. The parking route stored through the execution of the background storage processing is hereinafter referred to as “post-registration manual parking route.” Thus, when the own vehicle 100 is parked at the registered position by the manual parking operation after the storage of the registered route, the parking assist ECU 10 stores, as the post-registration manual parking route, the route along which the own vehicle 100 has traveled until the own vehicle 100 is parked at the registered position by this manual parking operation.

Thus, when the parking assist ECU 10 determines that the own vehicle 100 is to be parked at the registered position by the manual parking operation after the storage of the registered route through the usual storage processing, the parking assist ECU 10 executes the background storage processing, to thereby store the post-registration manual parking route. Further, each time the parking assist ECU 10 determines that the own vehicle 100 is to be parked at the registered position by the manual parking operation after the storage of the registered route through the usual storage processing, the parking assist ECU 10 executes the background storage processing, to thereby store the post-registration manual parking route. As a result, the post-registration manual parking routes are accumulated in the ROM 12.

### 4. Update Processing

The update processing is executed when the own vehicle 100 is parked at the registered position by the manual parking operation after the registered route is stored. Specifically, the update processing is executed when the number of times of the parking of the own vehicle 100 at the registered position by the manual parking operation after the registered route is stored, that is, the number of times of execution of the background storage processing, in still other words, the number of the post-registration manual parking routes accumulated through the execution of the background storage processing, reaches a number set in advance (set number). The set number is an integer equal to or larger than 1, and may be 1 or 2 or more. Description is now given of the update processing.

When the update processing is executed, the parking assist ECU 10 updates the registered route through use of the post-registration manual parking route stored through the execution of the background storage processing. Moreover, when a plurality of post-registration manual parking routes are accumulated through a plurality of times of the execution of the background storage processing, the parking assist ECU 10 updates the registered route through use of the accumulated plurality of post-registration manual parking routes in the update processing.

In the at least one embodiment, the parking assist ECU 10 calculates an update route based on the registered route and one or a plurality of post-registration manual parking routes, and updates the registered route through use of the calculated update route. At this time, the update route may be calculated as a route for traveling in a region between the registered route and the post-registration manual parking routes. For example, the update route is calculated by averaging the registered route and the post-registration manual parking routes. In other words, the update route is calculated by executing averaging processing of taking the average between the registered route and the post-registration manual parking routes.

FIG. 7 shows an example of the post-registration manual parking route stored through the execution of the background storage processing. This post-registration manual parking route is formed of the forward route FR for the forward travel from the start position P0 to the turn-back position P1 and the backward route RR for backward travel from the turn-back position P1 to the parking position P2 in the parking space PS.

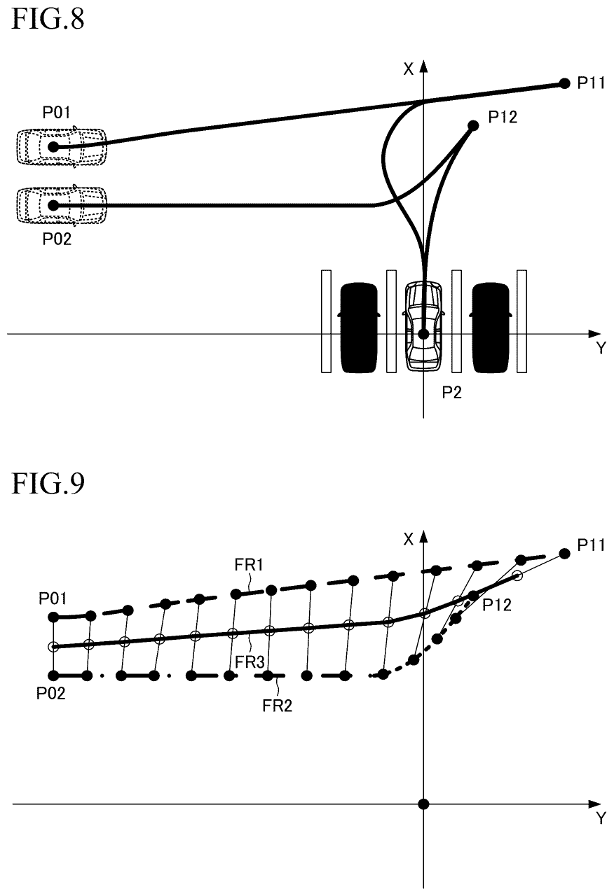

FIG. 8 is a view for illustrating both of the registered route of FIG. 5 and the post-registration manual parking route of FIG. 7. As illustrated in FIG. 8, a start position P01 of the registered route and a start position P02 of the post-registration manual parking route are positions different from each other. Moreover, a turn-back position P11 of the registered route and a turn-back position P12 of the post-registration manual parking route are also positions different from each other. Meanwhile, an end position of the registered route and an end position of the post-registration manual parking route are the positions P2 which are substantially the same as each other. When the averaging processing is to be executed, the parking assist ECU 10 divides each route into the forward route and the backward route to execute the averaging processing.

FIG. 9 is a graph for showing both of the forward route of the registered route and the forward route of the post-registration manual parking route. In FIG. 9, a forward route FR1 of the registered route is indicated as a broken line, and a forward route FR2 of the post-registration manual parking route is indicated as a one-dot chain line. When the averaging processing for the forward routes is to be executed, the parking assist ECU 10 extracts “m” coordinate points from a group of a plurality of points forming the forward route FR1 of the registered route, and extracts “m” coordinate points from a group of a plurality of points forming the forward route FR2 of the post-registration manual parking route. In FIG. 9, 14 coordinate points forming each route are extracted. Those coordinate points are indicated as points of black circles on an X-Y coordinate plane of FIG. 9.

After that, the parking assist ECU 10 calculates a coordinate position of a middle point of a line segment connecting between two coordinate points which are at the same position in sequences from the start positions P01 and P02 of the respective routes FR1 and FR2 out of the extracted coordinate points. In FIG. 9, the calculated coordinate positions are indicated as points of outlined circles. A route indicated by line segments each connecting between the coordinate points calculated as described above is an update route FR3 of the forward route. In FIG. 9, the update route FR3 of the forward route is indicated as a solid line.

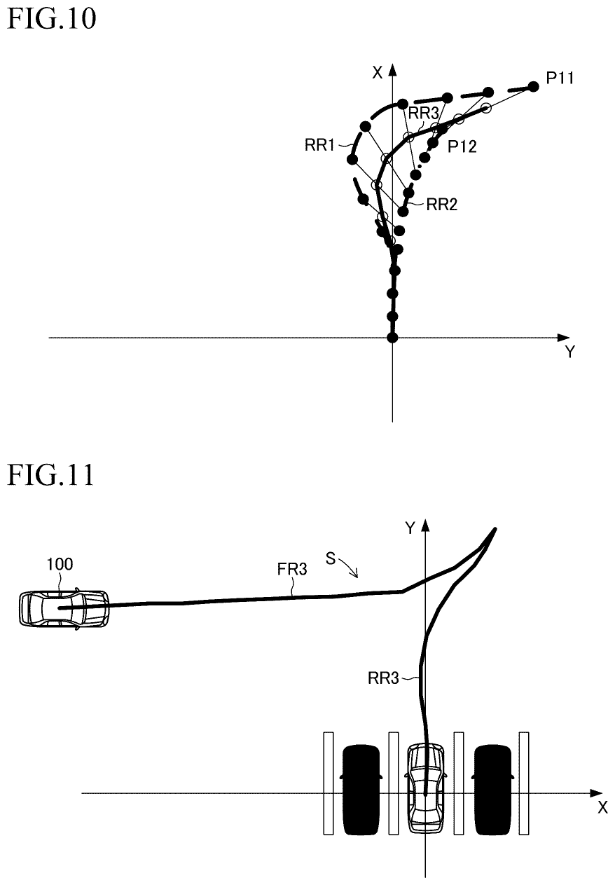

FIG. 10 is a graph for showing both of the backward route of the registered route and the backward route of the post-registration manual parking route. In FIG. 10, a backward route RR1 of the registered route is indicated as a broken line, and a backward route RR2 of the post-registration manual parking route is indicated as a one-dot chain line. When the averaging processing for the backward routes is to be executed, the parking assist ECU 10 extracts “m” coordinate points from a group of a plurality of points forming the backward route RR1 of the registered route, and extracts “m” coordinate points from a group of a plurality of points forming the backward route RR2 of the post-registration manual parking route. In FIG. 10, 12 coordinate points forming each route are extracted. Those coordinate points are indicated as points of black circles on an X-Y coordinate plane of FIG. 10.

After that, the parking assist ECU 10 calculates a coordinate position of a middle point of a line segment connecting between two coordinate points which are at the same position in sequences from the turn-back positions P11 and P12 of the respective routes RR1 and RR2 out of the extracted coordinate points. In FIG. 10, the calculated coordinate positions are indicated as points of outlined circles. A route indicated as line segments each connecting between the coordinate points calculated as described above is an update route RR3 of the backward route. In FIG. 10, the update route RR3 of the backward route is indicated as a solid line.

The parking assist ECU 10 connects the update route FR3 of the forward route and the update route RR3 of the backward route to each other after the calculation thereof. As a result, the update route is generated. FIG. 11 is a view for illustrating the update route. An update route S of FIG. 11 is a route which passes through the center position between the registered route of FIG. 5 and the post-registration manual parking route of FIG. 7. As described above, the parking assist ECU 10 averages the registered route and the post-registration manual parking route, to thereby calculate the update route.

Incidentally, the case in which the driver of the own vehicle 100 parks the own vehicle 100 at the registered position by the manual parking operation even when the registered route is stored is highly probably a case in which the driver of the own vehicle 100 considers that the registered route is an inappropriate route having a large number of wasteful routes. In this case, it is considered that the driver of the own vehicle 100 operates the own vehicle 100 such that the own vehicle 100 travels along a route without waste by the manual parking operation. That is, the post-registration manual parking route is highly probably a more appropriate route than the registered route. Thus, the update route calculated by averaging the registered route and the post-registration manual parking route is a route closer to an optimal route than the registered route.

The above-mentioned example is an example of calculating the update route by averaging, when the number of the accumulated post-registration manual parking routes is one, this post-registration manual parking route and the registered route. When “n” (“n” is an integer equal to or more than 2) post-registration manual parking routes are accumulated, the update route can be calculated through averaging, for example, as described below. Positions of “m” coordinate points extracted from a post-registration manual parking route La which is accumulated an a-th time out of the “n” post-registration manual parking routes are represented by Ca1(Xa1, Ya1), Ca2(Xa2, Ya2), . . . , Cam(Xam, Yam). The position of the coordinate point which is at an s-th position from the start position (or the turn-back position) of the post-registration manual parking route La out of the extracted coordinate points can be expressed as Cas(Xas, Yas). Moreover, positions of “m” coordinate points extracted from the registered route are represented by Ct1(Xt1, Yt1), Ct2(Xt2, Yt2), . . . , Ctm(Xtm, Ytm). The position of the coordinate point which is at the s-th position from the start position (or the turn-back position) of the registered route out of the extracted coordinate points can be expressed as Cts(Xts, Yts). In this case, an X component Xavs of an average position of the coordinate points at the s-th position from the start position (or the turn-back position) of the routes can be calculated as given by Expression (1) and a Y component Yavs thereof can be calculated as given by Expression (2).

$${X}_{avs} = \frac{{\sum }_{a = 1}^{n} {X}_{as} + Xts}{n + 1} \qquad ( 1 )$$

$${Y}_{avs} = \frac{{\sum }_{a = 1}^{n} {Y}_{as} + {X}_{ts}}{n + 1} \qquad ( 2 )$$

The parking assist ECU 10 uses Expression (1) and Expression (2) to sequentially calculate the coordinate points at the “m” averaged positions. After that, the update route can be calculated by connecting the coordinate points at the calculated averaged positions to each other.

The parking assist ECU 10 updates the registered route to the update route after the update route is calculated. Thus, when the update processing is executed, the newly calculated update route is used to execute the automatic parking control.

The update route is the newly calculated parking route, and hence the information with which the update route can be identified, for example, the peripheral image acquired from the camera sensor 212 does not exist. Thus, when the own vehicle 100 is caused to travel along the update route through the automatic parking control for the first time, a target with which the peripheral image acquired from the camera sensor 212 is compared does not exist. In this respect, the parking assist ECU 10 in the at least one embodiment calculates an amount of deviation of the update route (registered route after the update) from the registered route before the update based on a comparison between the calculated update route and the registered route before the update. Further, the parking assist ECU 10 corrects, in accordance with the calculated deviation amount, the position of the feature point (for example, a position of a marking drawn on the road surface) in the peripheral image with which the registered route before the update can be identified. After that, the parking assist ECU 10 controls the own vehicle 100 such that the position of the feature point in the peripheral image acquired from the camera sensor 212 when the automatic parking control is executed matches the corrected position. With this control, the own vehicle 100 can be caused to travel along the update route. When the own vehicle 100 is caused to travel along the update route once, the update route can be identified by storing the peripheral image information acquired from the camera sensor 212 at this time. Thus, when the own vehicle 100 is caused to travel along the update route through the automatic parking control for the second and subsequent times, it is possible to control the own vehicle 100 such that the own vehicle 100 travels along the update route through use of the information (peripheral image information) with which the stored update route can be identified.

Moreover, the parking assist ECU 10 averages the information indicating the travel state (the speed, the acceleration, and the like) stored for the registered route before the update and the information indicating the travel state (the speed, the acceleration, and the like) acquired when the own vehicle 100 travels along the post-registration manual parking route, to thereby calculate average values of the travel state, for example, an average value of the speed and an average value of the acceleration. After that, when the automatic parking control is executed such that the own vehicle 100 travels along the update route, the parking assist ECU 10 controls the drive device 30 and the braking device 40 such that the travel state of the own vehicle 100 matches the calculated average values. As a result, the own vehicle 100 can be controlled such that the own vehicle 100 travels along the update route at the predetermined speed through the automatic parking control.

As described above, in the at least one embodiment, the parking assist ECU 10 executes the background storage processing, to thereby store and accumulate the post-registration manual parking routes, which are the manual parking routes after the registered route is stored. After that, the parking assist ECU 10 uses the post-registration manual parking routes to execute the update processing, to thereby update the registered route. Specifically, the parking assist ECU 10 updates the registered route based on the registered route and the post-registration manual parking routes. For example, the parking assist ECU 10 averages the registered route and the post-registration manual parking routes, to thereby calculate the update route. After that, the parking assist ECU 10 updates the registered route to the calculated update route. The registered route thus updated is closer to an appropriate route than the registered route before the update. That is, the registered route can be brought closer to an appropriate route by executing the update processing. Thus, appropriate automatic parking control can be executed. As a result, it is expected that the automatic parking control be fully used.

### (Specific Operations)

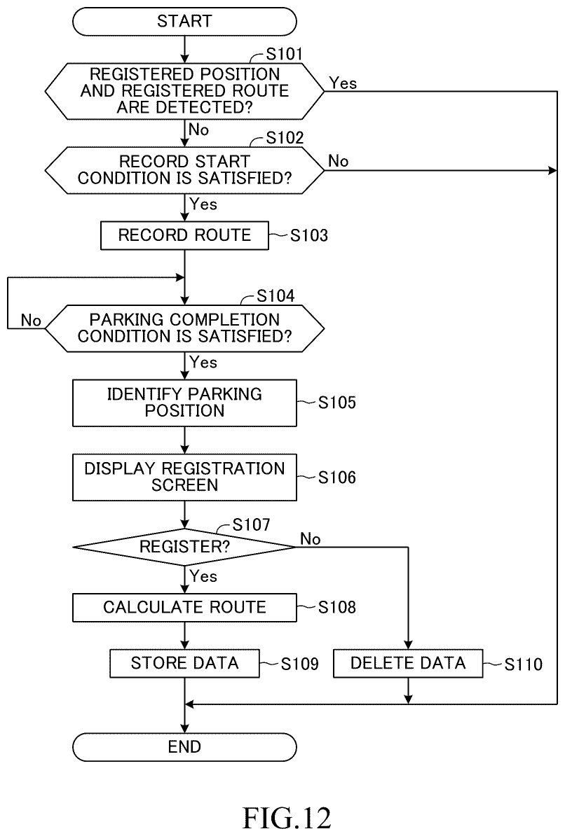

FIG. 12 is a flowchart for illustrating an example of a program executed by the CPU 11 for the parking assist ECU 10 to execute the usual storage processing. This program is repeatedly executed each time a predetermined short period of time elapses during the travel of the own vehicle 100. When the execution of this program is started, the CPU 11 first determines whether or not the registered position and the registered route are detected in the neighborhood region of the own vehicle 100 in Step 101 (hereinafter Step is abbreviated as “S”) of FIG. 12. In this case, the CPU 11 can determine whether or not the registered position and the registered route are detected in the neighborhood region of the own vehicle 100 by comparing the position information on the registered position stored in the ROM 12 and the current position information on the own vehicle 100 with each other.

When the registered position and the registered route are detected in the neighborhood region of the own vehicle 100 (Yes in S101), the CPU 11 finishes the execution of this program. Meanwhile, when the registered position and the registered route are not detected in the neighborhood region of the own vehicle 100 (NO in S101), the processing executed by the CPU 11 proceeds to S102.

In S102, the CPU 11 determines whether or not the record start condition is satisfied. When the record start condition is not satisfied (No in S102), the CPU 11 finishes the execution of this program. Meanwhile, when the record start condition is satisfied (Yes in S102), the processing proceeds to S103.

In S103, the CPU 11 starts the execution of the route record processing. As a result, the data on the travel information including the information with which the travel route of the own vehicle 100 can be identified and the information indicating the travel state is recorded in the ring buffer area of the RAM 13. After that, the processing proceeds to S104.

In S104, the CPU 11 determines whether or not a parking completion condition is satisfied. The parking completion condition is set in advance as a condition which is satisfied when the own vehicle 100 has completed the parking at any position. For example, the parking completion condition is satisfied when the vehicle speed of the own vehicle 100 is 0, the shift position of the transmission 34 is the parking position, and a parking brake provided to the own vehicle 100 is active.

When the parking completion condition is not satisfied (No in S104), the CPU 11 repeats the processing step of S104. In this case, the route record processing is continued. Meanwhile, when the parking completion condition is satisfied (Yes in S104), the own vehicle 100 is parked at a predetermined parking position. In this case, the processing proceeds to S105. In S105, the CPU 11 finishes the route record processing, and identifies the current position of the own vehicle 100 as the parking position. After that, the processing proceeds to S106. In S106, the CPU 11 outputs a control signal to the display ECU 71 so that a registration screen is displayed on the display 72. This registration screen is a screen for inputting presence or absence of an intention of registering the parking position at which the own vehicle 100 is parked and the route (parking route) along which the own vehicle 100 has traveled by the manual parking operation until the own vehicle 100 is parked at this parking position. Thus, on the registration screen, a character string for asking whether or not the parking position and the parking route are to be registered, an approval icon for inputting the intention of registering the parking position and the parking route, and a denial icon for inputting the intention of not registering the parking position and the parking route are displayed.

After that, the CPU 11 determines whether or not the parking position and the parking route are to be registered (S107). In this case, the CPU 11 determines that the parking position and the parking route are to be registered when the approval icon of the registration screen is tapped, and determines that the parking position and the parking route are not to be registered when the disapproval icon is tapped.

When the parking position and the parking route are not to be registered (No in S107), the recorded information (data) is deleted (S110). After that, this program is finished. Meanwhile, when the parking position and the parking route are to be registered (Yes in S107), the processing proceeds to S108. In S108, the CPU 11 calculates the parking route based on the recorded travel information and parking position. In this case, for example, the CPU 11 can calculate the coordinate components of the group of points representing the parking route on the X-Y coordinate plane having the own vehicle 100 at the parking position as the origin, the X axis passing through the origin and extending in the front-and-rear direction of the own vehicle 100, and the Y axis passing through the origin and extending in the width direction of the own vehicle 100. After the calculation of the parking route, the processing proceeds to S109.

In S109, the CPU 11 stores the information (data) indicating the calculated parking route, the information (peripheral image data) with which the parking route can be identified, the information (data) indicating the travel state of the own vehicle 100, and the information (data) indicating the parking position in a predetermined location of the ROM 12. As a result, the parking route is stored as the registered route and the parking position is stored as the registered position. After that, the CPU 11 finishes this program.

As a result of the execution of the program of FIG. 12 by the CPU 11, the parking assist ECU 10 executes the usual storage processing. As a result, the registered route and the registered position are stored.

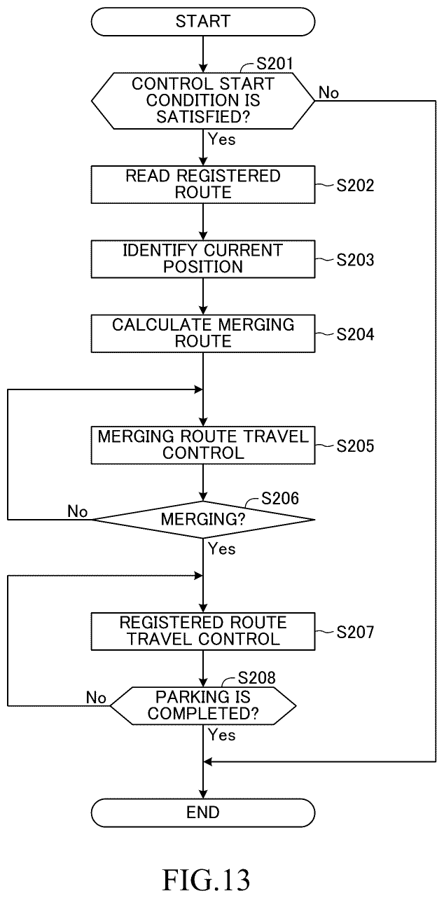

FIG. 13 is a flowchart for illustrating an example of a program executed by the CPU 11 for the parking assist ECU 10 to execute the automatic parking control. This program is repeatedly executed during the travel of the own vehicle 100. When the execution of the program of FIG. 13 is started, the CPU 11 determines whether or not the control start condition for the automatic parking control is satisfied in S201 of FIG. 13. The control start condition is satisfied when, for example, the control start signal is transmitted from the proposal image displayed on the display 72 as described above. The control start condition is not limited to this condition, and the determination can be made based on various conditions.

When the control start condition is not satisfied (No in S201), the CPU 11 finishes the execution of this program. Meanwhile, when the control start condition is satisfied (Yes in S201), the processing proceeds to S202.

In S202, the CPU 11 reads the registered route detected in the neighborhood region of the own vehicle 100. After that, the CPU 11 identifies the current position of the own vehicle 100 (S203). Next, the CPU 11 calculates the merging route from the current travel position to the merging point at which the own vehicle 100 starts to travel along the registered route (S204).

The CPU 11 executes merging route travel control after the calculation of the merging route (S205). As a result, the drive device 30, the braking device 40, the steering device 50, and the like of the own vehicle 100 are controlled such that the own vehicle 100 travels along the merging route.

After that, the CPU 11 determines whether or not the own vehicle 100 has reached the merging point between the merging route and the registered route (S206). When the own vehicle 100 has not reached the merging point (No in S206), the processing returns to S205. In this case, the merging route travel control is continued. Meanwhile, when the own vehicle 100 has reached the merging point (Yes in S206), the processing proceeds to S207.

When the own vehicle 100 has reached the merging point, the own vehicle 100 subsequently travels along the registered route. Thus, in S207, the CPU 11 executes registered route travel control. As a result, the drive device 30, the braking device 40, the steering device 50, the shift change device 60, and the like of the own vehicle 100 are controlled such that the own vehicle 100 travels along the registered route and is then parked at the registered position.

After that, the CPU 11 determines whether or not the parking of the own vehicle 100 at the registered position is completed (S208). When the parking at the registered position is not completed (No in S208), the processing returns to S207. In this case, the registered route travel control is continued. Meanwhile, when the parking at the registered position is completed (Yes in S208), the CPU 11 executes predetermined finish processing, and then finishes this program.

As a result of the execution of the program of FIG. 13 by the CPU 11, the parking assist ECU 10 executes the automatic parking control. As a result, the own vehicle 100 automatically travels along the registered route, and is then parked at the registered position.

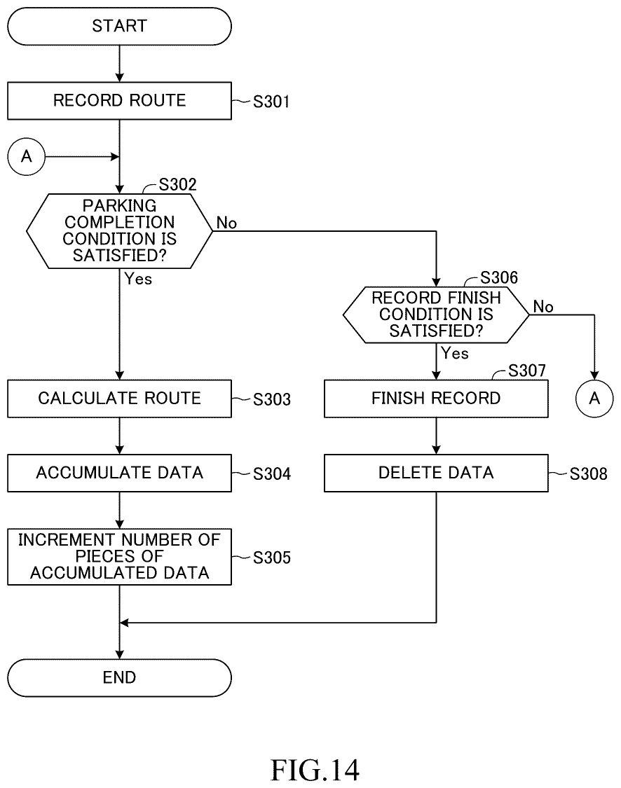

FIG. 14 is a flowchart for illustrating an example of a program executed by the CPU 11 in order for the parking assist ECU 10 to execute the background storage processing. The program of FIG. 14 is executed when, for example, it is determined that the control start condition is not satisfied in S201 of the program of FIG. 13, but the start condition for this program is not limited to this case. This program is executed when it is determined that the own vehicle 100 is to be parked at the registered position by the manual parking operation after the registered route is stored.

When the execution of this program is started, the CPU 11 starts the route record processing in S301 of FIG. 14. As a result, the data on the travel information including the information with which the travel route of the own vehicle 100 can be identified and the information indicating the travel state is recorded in the ring buffer of the RAM 13.

After that, the CPU 11 determines whether or not the parking completion condition is satisfied (S302). The parking completion condition is set in advance as the condition which is satisfied when the own vehicle 100 is parked at the registered position. For example, the parking completion condition is satisfied when the own vehicle 100 exists at the registered position or a position extremely close to the registered position, the vehicle speed of the own vehicle 100 is 0, the shift position of the transmission 34 is the parking position, and the parking brake provided to the own vehicle 100 is active.

When the parking completion condition is not satisfied (No in S302), the processing proceeds to S306. In S306, the CPU 11 determines whether or not a record finish condition is satisfied. The record finish condition is set in advance as a condition which is satisfied when it is possible to determine that the travel state of the own vehicle 100 is not the travel state for parking the own vehicle 100 at the registered position. For example, the record finish condition is satisfied when the travel position of the own vehicle 100 is greatly deviated from the registered route.

When the record finish condition is not satisfied (No in S306), the processing returns to S302. In this case, the route record processing is continued. Meanwhile, the record finish condition is satisfied (Yes in S306), the processing proceeds to S307. In S307, the CPU 11 finishes the route record. After that, the CPU 11 deletes the already stored data on the travel information on the own vehicle 100 (S308), and then finishes this program.

Moreover, when the CPU 11 determines that the parking completion condition is satisfied in S302 (Yes in S302), the CPU 11 finishes the route record processing, and calculates the parking route (post-registration manual parking route) along which the own vehicle 100 has traveled until the own vehicle 100 is parked at the registered position (S303). After that, the CPU 11 stores the information (data) indicating the calculated parking route, the information (peripheral image data) with which the parking route can be identified, and the information (data) indicating the travel state of the own vehicle 100 at the predetermined storage location in the ROM 12 (S304). As a result, the post-registration manual parking route is accumulated. After that, the CPU 11 increments the number of pieces of the accumulated data (S305). The number of pieces of the accumulated data is the number of post-registration manual parking routes accumulated for one registered position. An initial value of the number of pieces of the accumulated data is 0. After that, the CPU 11 finishes this program.

As a result of the execution of the program of FIG. 14 by the CPU 11, the background storage processing is executed, so that the data indicating the parking route (post-registration manual parking route) until the own vehicle 100 is parked at the registered position by the manual parking operation after storing the registered route is stored and accumulated.

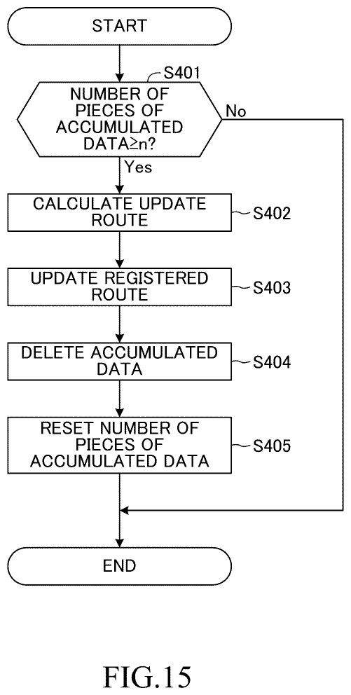

FIG. 15 is a flowchart for illustrating an example of a program executed by the CPU 11 in order for the parking assist ECU 10 to execute the update processing. This program is executed each time the post-registration manual parking route is stored as a result of the execution of the background storage processing. When the execution of this program is started, in S401 of FIG. 15, the CPU 11 determines whether or not the number of pieces of the accumulated data, that is, the number of the post-registration manual parking routes accumulated through the execution of the background storage processing is equal to or larger than the set number “n”. The set number “n” is an integer equal to or larger than 1. The set number “n” may be set in advance, may be set by the driver of the own vehicle 100, or may be set by the CPU 11.

When the number of pieces of the accumulated data is smaller than “n” (No in S401), the CPU 11 finishes this program. Meanwhile, when the number of pieces of the accumulated data is “n” or more (Yes in S401), the processing proceeds to S402.

In S402, the CPU 11 calculates the update route. The update route is calculated based on the registered route and the post-registration manual parking routes as described above. In this case, the update route can be calculated through, for example, the averaging processing described above.

After the calculation of the update route, the CPU 11 updates the registered route to the update route (S403). After that, the accumulated data is deleted (S404), and the number of pieces of the accumulated data is reset (S405). As a result, the number of pieces of accumulated data is reset to 0. After that, the CPU 11 finishes this program.

As a result of the execution of the update processing described above by the CPU 11, the update route is calculated each time the number of pieces of the accumulated data reaches “n”. After that, the registered route is updated to the calculated update route.

The at least one embodiment of the present disclosure is described above, but the parking assist apparatus according to the present disclosure should not be limited to the at least one embodiment. For example, the following modification examples can be given.

### Modification Example 1

In the at least one embodiment, there has been described the example in which the registered route and the post-registration manual parking routes are used to calculate the update route through the averaging processing. When this averaging processing is to be executed, by weighting the routes for calculation, it is possible to increase a degree of influence of a predetermined route or a part of the predetermined route on the calculation of the update route. In particular, when it is possible to determine, as an optimal route, a part of a certain route of the post-registration manual parking route accumulated through the execution of the background storage processing, a weight of this part may be increased to execute the averaging processing such that this part has a greater influence on the update route when the update route is calculated.

### Modification Example 2

The parking assist ECU 10 may be configured to execute exclusion processing of deleting (excluding) abnormal data determined to be inappropriate as data to be used for the update processing from the data indicating the post-registration manual parking routes accumulated through the execution of the background storage processing. Examples of the abnormal data include data indicating a route of a part along which the own vehicle 100 has traveled by a driving operation other than the driving operation for parking the own vehicle 100 at the registered position and data indicating a part which can be determined to be an obviously wasteful route.

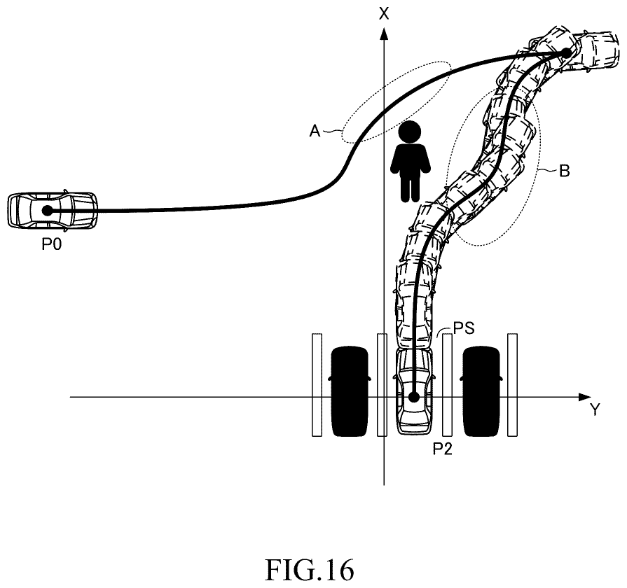

FIG. 16 is a view for illustrating an example of an inappropriate post-registration manual parking route stored through the execution of the background storage processing. The post-registration manual parking route illustrated in FIG. 16 includes parts (a part A and a part B) along which the own vehicle 100 has traveled by an avoidance operation for avoiding an obstacle (for example, a pedestrian). In this case, data (data indicating the part A and the part B) on the routes caused by the driving operation for avoiding the object is deleted (excluded) by the parking assist ECU 10 executing the exclusion processing.

The data to be deleted (excluded) is not limited to a route for avoiding an obstacle as illustrated in FIG. 16. For example, also in a case in which a route including meandering routes is formed as a result of the driver wastefully repeating a turn operation of the steering wheel 53a, data on those routes can be deleted (excluded).

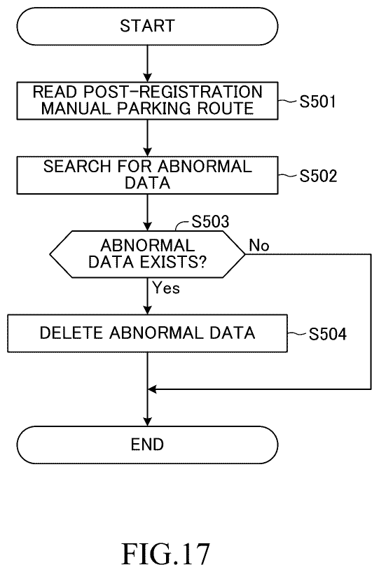

FIG. 17 is a flowchart for illustrating an example of a program executed by the CPU 11 in order for the parking assist ECU 10 to execute the exclusion processing. This program is started when the post-registration manual parking route is stored through the background storage processing. When the execution of this program is started, the CPU 11 reads the data on the post-registration manual parking route stored in S501 of FIG. 17, and then searches for abnormal data from the read data on the post-registration manual parking route (S502). The abnormal data can be retrieved based on, for example, data indicating the travel state of the own vehicle 100 acquired together with the image data for identifying the post-registration manual parking route, in particular, whether or not the acceleration, the steering rotation angle, or a change amount of the steering rotation angle exceeds a threshold value.

After the search for the abnormal data in S502, the CPU 11 determines whether or not abnormal data is retrieved (S503). When abnormal data is not retrieved (No in S503), the CPU 11 finishes this program. Meanwhile, when abnormal data is retrieved (Yes in S503), the processing proceeds to S504. In S504, the CPU 11 deletes the retrieved abnormal data. After that, the CPU 11 finishes this program.

As a result of the execution of the program of FIG. 17 by the CPU 11, the abnormal data (outlier) is deleted (excluded) from the accumulated data. Thus, the information on an inappropriate route is excluded, and hence it is possible to quickly bring the update route closer to an appropriate route through the execution of the update processing.

The above-mentioned example is an example in which the abnormal data is deleted from the data on the post-registration manual parking route, but the weight may be adjusted such that the abnormal data is less likely to be reflected in the update processing. For example, it is possible to reduce the influence of the abnormal data on the update route by setting a smaller value as the weight for data indicating a route considered to be abnormal during the execution of the update processing.

### Modification Example 4

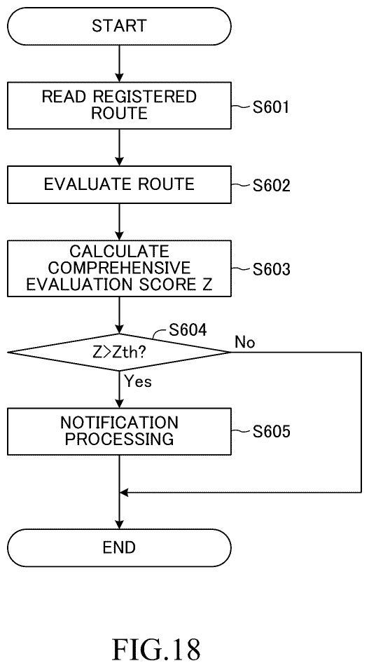

The parking assist ECU 10 can execute notification processing of notifying that the registered route is optimized when the registered route is optimized up to a predetermined level through the execution of the update processing. FIG. 18 is a flowchart for illustrating an example of a program executed by the CPU 11 for the parking assist ECU 10 to execute the notification processing. This program is executed each time the update processing is executed. When the execution of the program of FIG. 18 is started, the CPU 11 reads the updated registered route in S601 of FIG. 18.

After that, the CPU 11 evaluates the read registered route (S602). At this time, the CPU 11 sets a length, the maximum radius, and the like of the route as evaluation targets, and gives an evaluation score to each item. For example, as the length of the route is shorter, this route can be considered to be better. Thus, as the length of the route is shorter, the evaluation score is higher. Moreover, as the maximum radius of the route is larger, the route can be considered to be a smoother route. Thus, as the maximum radius is larger, the evaluation score is higher. The registered route is evaluated in this manner by calculating the evaluation score for each item.

After that, the CPU 11 sums the evaluation scores calculated for the respective items, to thereby calculate a comprehensive evaluation score Z (S603). The comprehensive evaluation score Z is a score which is higher as the registered route is more optimal.

After the calculation of the comprehensive evaluation score Z, the CPU 11 determines whether or not the comprehensive evaluation score Z is larger than a threshold score Zth (S604). When the comprehensive evaluation score Z is equal to or smaller than the threshold score Zth (No in S604), the CPU 11 finishes this program. Meanwhile, when the comprehensive evaluation score Z is larger than the threshold score Zth (Yes in S604), the processing proceeds to S605. In S605, the CPU 11 executes the notification processing. In this notification processing, the fact that the registered route is optimized is notified. For example, the display ECU 71 is controlled such that a character string such as “Registered route is optimized” is displayed on the display 72. As another example, a speaker provided to the own vehicle 100 is controlled such that a sound such as “Assist is now better” is generated in a cabin. After the execution of this notification control, the CPU 11 finishes this program.

As a result of the execution of the program of FIG. 18 by the CPU 11, the optimization of the registered route is notified when the registered route is optimized to the predetermined level. As a result, it is possible to raise such motivation of the driver of the own vehicle 100 that the driver uses the parking assist apparatus 1 to automatically park the own vehicle 10, and hence the use of the parking assist apparatus is promoted.

### Modification Example 5

In Modification Example 4, there has been described the example that the optimization of the registered route is notified when the registered route is optimized to the predetermined level, but there may be provided a configuration in which optimization of the travel state on the registered route is notified when the travel state is optimized to a predetermined level. For example, when a change amount of the vehicle speed and the change amount of the steering rotation angle become predetermined threshold values or smaller, the improvement of the travel state (driving state) on the registered route can be notified. Moreover, there may be provided a configuration in which the optimization of the registered route and the travel state on the registered route may be notified when the registered route and the travel state are optimized to the predetermined levels. As described above, the technology relating to the present disclosure may be modified without departing from the gist thereof.

Moreover, the technology in the present disclosure is a technology applicable to a technology conforming to ISO 20900 (partially automated parking system (PAPS)) and ISO 16787 (assisted parking system (APS)) which are standards.

What is claimed is:

1. A parking assist apparatus, comprising a control unit configured to store, as a registered route, a route along which an own vehicle has traveled until the own vehicle is parked at a predetermined parking position by a manual parking operation, and to execute automatic parking control of parking the own vehicle at the predetermined parking position by causing the own vehicle to travel along the registered route,
wherein the control unit is configured to execute update processing of updating, when the own vehicle is parked at the predetermined parking position by a manual parking operation after the registered route is stored, the registered route based on information on the manual parking operation.

2. The parking assist apparatus according to claim 1, wherein the control unit is configured to:
store, when the own vehicle is parked at the predetermined parking position by a manual parking operation after the registered route is stored, as a post-registration manual parking route, a route along which the own vehicle has traveled until the own vehicle is parked at the predetermined parking position by the manual parking operation; and
update, in the update processing, the registered route through use of the post-registration manual parking route.

3. The parking assist apparatus according to claim 2, wherein the control unit is configured to:
store the post-registration manual parking route each time the own vehicle is parked at the predetermined parking position by a manual parking operation after the registered route is stored, to thereby accumulate the post-registration manual parking route; and
update, in the update processing, the registered route through use of the accumulated post-registration manual parking routes.

4. The parking assist apparatus according to claim 3, wherein, in the update processing, the control unit is configured to average the registered route and the post-registration manual parking routes, to thereby calculate an update route, and to update the registered route to the calculated update route.

5. The parking assist apparatus according to claim 4, wherein the control unit is configured to execute exclusion processing of deleting abnormal data determined to be inappropriate as data to be used for the update processing, from data representing the post-registration manual parking route.

6. The parking assist apparatus according to claim 5, wherein the abnormal data includes data indicating a route caused by a driving operation for avoiding an obstacle.
